(19) United States
(12) Patent Application Publication
(10) Pub. No.: US 2020/0398738 A1
(43) Pub. Date: Dec. 24, 2020

(54) HEADLAMP FOR VEHICLE AND METHOD FOR CONTROLLING THE SAME

(71) Applicant: Hyundai Mobis Co., Ltd., Seoul (KR)

(72) Inventors: Hyun Soo Lee, Yongin-si (KR); Young Geun Jun, Yongin-si (KR)

(21) Appl. No.: 16/906,974

(22) Filed: Jun. 19, 2020

(30) Foreign Application Priority Data
Jun. 20, 2019 (KR) 10-2019-0073409
Jun. 20, 2019 (KR) 10-2019-0073413

(51) Int. Cl. B60Q 1/14; B60Q 1/00; H05B 47/125

(52) U.S. Cl. CPC B60Q 1/143; B60Q 1/0023; B60Q 1/0041; B60Q 2300/054; B60Q 2300/43; B60Q 2300/112; B60Q 2300/122; H05B 47/125

(57) ABSTRACT

A headlamp for a vehicle including a low beam source having a plurality of low beam elements arranged in a designated matrix; a high beam source having a plurality of high beam elements arranged in a designated matrix; and a control unit configured to generate a darkness area or light area by selectively turning on/off the high beam elements and the low beam element based on a designated matrix beam pattern, according to whether a target is detected.

### CROSS-REFERENCE TO RELATED APPLICATION

This application claims priority from and the benefit of Korean Patent Application No. 10-2019-0073413 and Korean Patent Application No. 10-2019-0073409, filed on Jun. 20, 2019, which are hereby incorporated by reference for all purposes as if set forth herein.

### BACKGROUND

### Field

Exemplary embodiments relate to a headlamp for a vehicle and a method for controlling the same, and more particularly, to a headlamp for a vehicle, which can improve the visibility of a driver while preventing glare of the driver, and a method for controlling the same.

### Discussion of the Background

In general, a headlamp is installed on either side of the front of a vehicle, and includes a low beam source and a high beam source.

The low beam source has a plurality of low beam elements arranged in a line, and the high beam source has a plurality of high beam elements arranged in a line.

The headlamp is implemented to partially turn off or on a high beam when an oncoming vehicle or forward vehicle is detected ahead of a vehicle through a camera. As such, the high beam may be partially turned off or on to secure the visibility of a driver.

In the conventional headlamp, however, the plurality of high beam elements are arranged in a line in the high beam source. Thus, as illustrated in FIG. 1, the headlamp turns off only some high beam elements which emit light at an angle corresponding to the left and right positions of the vehicle, thereby forming a darkness area only in a part of a side-to-side section (or horizontal section).

Such a beam pattern is not divided in a longitudinal direction. Therefore, when another vehicle (for example, oncoming vehicle or forward vehicle) or a sign appears ahead of the vehicle, the headlamp forms an excessive size of darkness area even though a small darkness area is needed in the longitudinal direction (top-to-bottom direction). Thus, the visibility of the driver may be degraded.

The related art of the present disclosure is disclosed in Korean Patent Application No. 2013-0009324 published on Jan. 23, 2013 and entitled “LED Headlamp”.

The above information disclosed in this Background section is only for enhancement of understanding of the background of the invention and, therefore, it may contain information that does not constitute prior art.

### SUMMARY

Exemplary embodiments provide a headlamp for a vehicle, which can improve the visibility of a driver while preventing glare of the driver, caused by a sign, and implement an EDBL (Electric Dynamic Bending Light) function, and a method for controlling the same.

Additional features of the invention will be set forth in the description which follows, and in part will be apparent from the description, or may be learned by practice of the invention.

An exemplary embodiment provides a headlamp for a vehicle including: a low beam source having a plurality of low beam elements arranged in a designated matrix; a high beam source having a plurality of high beam elements arranged in a designated matrix; and a control unit configured to generate a darkness area or light area by selectively turning on/off the high beam elements and the low beam element based on a designated matrix beam pattern, according to whether a target is detected.

The control unit may read a signal received from a camera unit, and determine whether the target is detected.

Each of the low beam source and the high beam source may include a center source and side sources disposed on both sides of the center source, and the center source may have higher beam pattern resolution than the side source.

The center source may have a greater luminous intensity than the side source.

The center source is set to a section of −X1° to +X1°, and the side sources are set to a section of −X1° to −X2° and a section of +X1° to +X2°, respectively, wherein −X1° is −8.4°, −X2° is −19.6°, +X1° is 8.4°, and +X2° is 19.6°.

The high beam source may have a plurality of high beam elements arranged in three or more rows, and include a first row set to a section of 0 to +Y1°, a second row set to a section of +Y1° to +Y2°, and a third row set to a section of +Y2° to +Y3°, wherein +Y1° is 2.1°, +Y2° is 4.2°, and +Y3° is 6.3°.

The low beam source may have a plurality of low beam elements arranged in three or more rows, and include a first row set to a section of 0 to −Y1°, a second row set to a section of −Y1° to −Y2°, and a third row set to a section of −Y2° to −Y3°, wherein −Y1° is 0.7°, +Y2° is −1.4°, and −Y3° is −2.1°.

The beam pattern may include, in the center source section of the high beam source: a forward vehicle following area constituted by rectangular beam patterns, each having a dimension of 2° in the top-to-bottom direction and 0.5° in the side-to-side direction, and serving as an area for an ADB (Adaptive Driving Beam) function; a glare prevention area constituted by rectangular beam patterns, each having a dimension of 2° in the top-to-bottom direction and 0.7° in the side-to-side direction, and serving as an area for preventing glare of a driver, caused by sign reflection; and an openness securing area constituted by rectangular beam patterns, each having a dimension of 2° in the top-to-bottom direction and 0.7° in the side-to-side direction, and serving as an area for making a driver feel openness, when there is no forward vehicle or oncoming vehicle.

The beam pattern may include, in the center source section of the low beam source: a low beam cut-off area constituted by square beam patterns, each having a dimension of 0.7°, and serving as an area for implementing cut-off and DBL (Dynamic Bending Light); and a spot light area constituted by square beam patterns, each having a dimension of 0.7°, and serving as an area for making a driver recognize the presence of a pedestrian or hazard ahead of the vehicle through a direct or indirect method.

The beam pattern may include, in the side source section of the high beam source, an oncoming vehicle following area constituted by rectangular beam patterns each having a dimension of 2° in the top-to-bottom direction and 2° to 3° in the side-to-side direction.

The beam pattern may include, in the side source section of the low beam source, an oncoming vehicle following area constituted by rectangular beam patterns each having a dimension of 0.7° in the top-to-bottom direction and 2° to 3° in the side-to-side direction.

Another exemplary embodiment provides a method for controlling a headlamp for a vehicle including, when an ADB (Adaptive Driving Beam) function is enabled while a high beam of the headlamp for a vehicle is turned on: receiving, by a control unit, information on a forward vehicle detected through a camera unit; and generating, by the control unit, a darkness area by controlling a beam pattern area corresponding to the forward vehicle in a designated forward vehicle following area among beam pattern areas of the headlamp for a vehicle.

The method may further include: receiving, by the control unit, information on a forward sign detected through the camera unit, when the ADB function is enabled while the high beam of the headlamp for a vehicle is turned on; and generating, by the control unit, a darkness area by controlling a beam pattern area corresponding to the forward sign in a designated glare prevention area among the beam pattern areas of the headlamp for a vehicle, when a glare prevention function is enabled.

The method may further include: receiving, by the control unit, information on a forward target detected through the camera unit, when the ADB function is enabled while the high beam of the headlamp for a vehicle is turned on; and generating, by the control unit, a light area or generating flickering at a designated frequency, by controlling a beam pattern area corresponding to the forward target in a designated spot light area among the beam pattern areas of the headlamp for a vehicle, when a spot light function is enabled.

When the high beam of the headlamp for a vehicle is turned on, a M/F (Multi-Function) switch may be set to auto. When a high beam enable condition is satisfied, the control unit may turn on the high beam. The high beam enable condition may indicate that vehicle speed is equal to or greater than designated speed, and there is no vehicle in a forward area and the traveling area is not a downtown area according to information detected through a camera unit, while the M/F switch is set to auto.

When the high beam enable condition is not satisfied, the control unit may enable a low beam, and turn on/off low beam elements for DBL according to a designated beam pattern depending on a steering angle.

When the M/F switch is not set to auto, the operation mode is switched to a manual mode such that the low beam or the high beam is manually operated.

Another exemplary embodiment provides a headlamp for a vehicle including: a low beam source having a plurality of low beam elements; a high beam source having a plurality of high beam elements arranged in two or more lines; and a control unit configured to turn off the high beam element corresponding to a target when the target is detected, and turn on the high beam element when no target is detected.

The high beam source may include: a center source having a plurality of high beam elements arranged in two or more lines; and a side source disposed on either side of the center source, and having the plurality of high beam elements arranged in a line.

The center source may have a greater luminous intensity than the side source.

The luminous intensities of the high beam elements may gradually decrease from the center of the center source toward the edge of the side source.

The center source may include: a first center high beam unit disposed in a lateral direction at the low beam source; and a second center high beam unit disposed in a lateral direction at the top of the first center high beam unit.

The first center high beam unit may emit a high beam at an inclination angle of 1.5 to 4° in a longitudinal direction.

The second center high beam unit may emit a high beam at an inclination angle of 0.7° to 4° in the longitudinal direction.

The low beam source may have the low beam elements arranged in a line.

The low beam source may have the low beam elements arranged in two or more lines.

The low beam source may be controlled to turn on some low beam elements arranged in a turning direction of a vehicle, and turn off some low beam elements arranged in the opposite side of the turning direction of the vehicle.

The control unit may read a signal received from a camera unit, and detect whether the target is detected.

Another exemplary embodiment provides a method for controlling a headlamp including: detecting a target; and turning off, by a control unit, a high beam element corresponding to the target when the target is detected, and turning on the high beam element when no target is detected.

The high beam source may include a center source and side sources, and the center source may have a greater luminous intensity than the side source.

The high beam source may include a center source and side sources, and have a luminous intensity that gradually decreases from the center of the center source toward the outermost portion of the side source.

The center high beam unit may include a first center high beam unit and a second center high beam unit, and the first center high beam unit may emit a high beam at an inclination angle of 1.5 to 4° in a longitudinal direction.

The center high beam unit may include a first center high beam unit and a second center high beam unit, and the second center high beam unit may emit a high beam at an inclination angle of 0.7 to 4° in a longitudinal direction.

The low beam source may be controlled to turn on some low beam elements arranged in a turning direction of the vehicle, and turn off some low beam elements arranged in the opposite side of the turning direction of the vehicle.

In accordance with the embodiments of the present disclosure, the headlamp and the method can improve the visibility of a driver while preventing glare of the driver, caused by a sign.

Furthermore, the light source may be arranged in a designate matrix to form a small darkness area in the lateral and longitudinal directions.

Furthermore, the headlamp and the method can previously identify the location of a pedestrian or a hazard, and make a driver recognize the location, thereby improving the traveling stability.

Furthermore, the headlamp and the method can adjust a light-on area in units of small areas in response to the turning direction of the vehicle, thereby improving the visibility of a driver in the nighttime. Furthermore, the headlamp and the method can perform the EDBL function to prevent a low beam of the low beam source from being emitted to an opponent vehicle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram schematically illustrating a matrix beam pattern of a source module in a conventional headlamp for a vehicle.

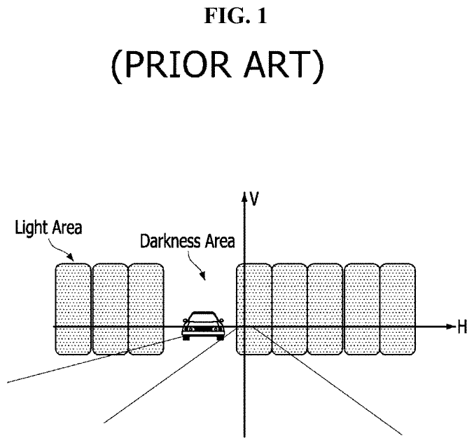

FIG. 2 is an exploded perspective view illustrating a headlamp for a vehicle in accordance with an embodiment of the present disclosure.

FIG. 3 is a diagram schematically illustrating a matrix beam pattern of a source module in the headlamp for a vehicle in accordance with the embodiment of the present disclosure.

FIG. 4 is a graph illustrating the road curvature distribution of a specific country in relation to the embodiment of the present disclosure.

FIG. 5 is a graph illustrating the standardized frequency distribution of vehicles for each camera angle in relation to the embodiment of the present disclosure.

FIGS. 6A, 6B, and 6C are graphs showing results obtained by analyzing camera detection distribution probabilities for a forward vehicle and oncoming vehicle in relation to the embodiment of the present disclosure.

FIG. 7 is a diagram comparatively illustrating a vehicle size depending on distance in order to decide beam pattern resolution for controlling the headlamp in accordance with the embodiment of the present disclosure.

FIGS. 8A and 8B are photographs comparatively showing simulation results on a curved road in order to decide beam pattern resolution for controlling the headlamp in accordance with the embodiment of the present disclosure.

FIGS. 9A, 9B, and 9C are photographs comparatively showing simulation results for deciding the resolution of a spot light beam pattern for controlling the headlamp in accordance with the embodiment of the present disclosure.

FIGS. 10A and 10B are photographs comparatively showing simulation results for checking visibility when a spot light function is operated and when the spot light function is not operated in FIG. 9.

FIG. 11 is a diagram illustrating a cut-off line rule for deciding the beam pattern resolution of a low beam cut-off area for controlling the headlamp in accordance with the embodiment of the present disclosure.

FIG. 12 is a flowchart for describing a method for controlling a headlamp for a vehicle in accordance with an embodiment of the present disclosure.

FIG. 13 is a diagram schematically illustrating a low beam source and a high beam source of a source module in a headlamp for a vehicle in accordance with another embodiment of the present disclosure.

FIG. 14 is a diagram schematically illustrating that low beam elements of the low beam source are arranged in two lines in the source module of the headlamp for a vehicle in accordance with the embodiment of the present disclosure.

FIG. 15 is a diagram schematically illustrating the high beam source of the source module in the headlamp for a vehicle in accordance with the embodiment of the present disclosure.

FIG. 16 is a diagram schematically illustrating that darkness areas are formed in high beam elements corresponding to targets in the headlamp for a vehicle in accordance with the embodiment of the present disclosure.

FIG. 17 is a diagram illustrating longitudinal inclination angles of low and high beams in the headlamp for a vehicle in accordance with the embodiment of the present disclosure.

FIG. 18 is a diagram schematically illustrating the width of a viewing angle of a driver depending on the curvature of a curved road in the headlamp for a vehicle in accordance with the embodiment of the present disclosure.

FIG. 19 is a flowchart for describing a method for controlling a headlamp for a vehicle in accordance with another embodiment of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Hereinafter, a headlamp for a vehicle and a method for controlling the same will be described below with reference to the accompanying drawings through various exemplary embodiments. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

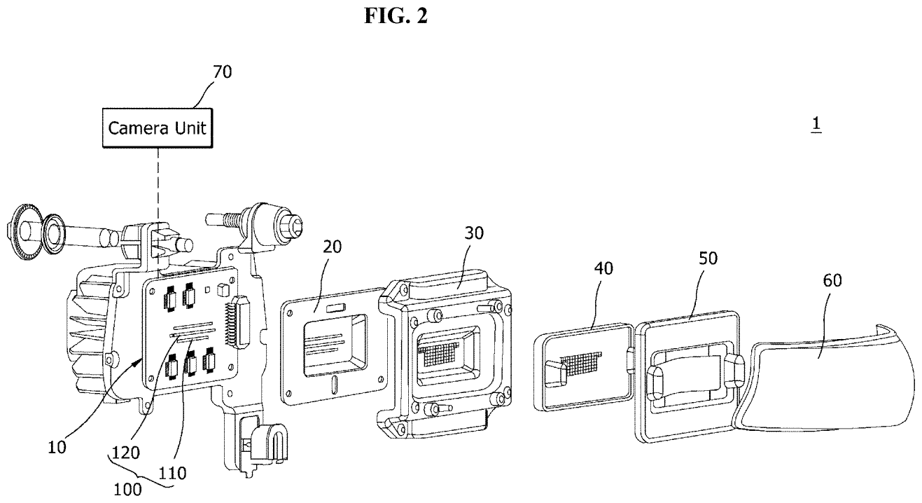

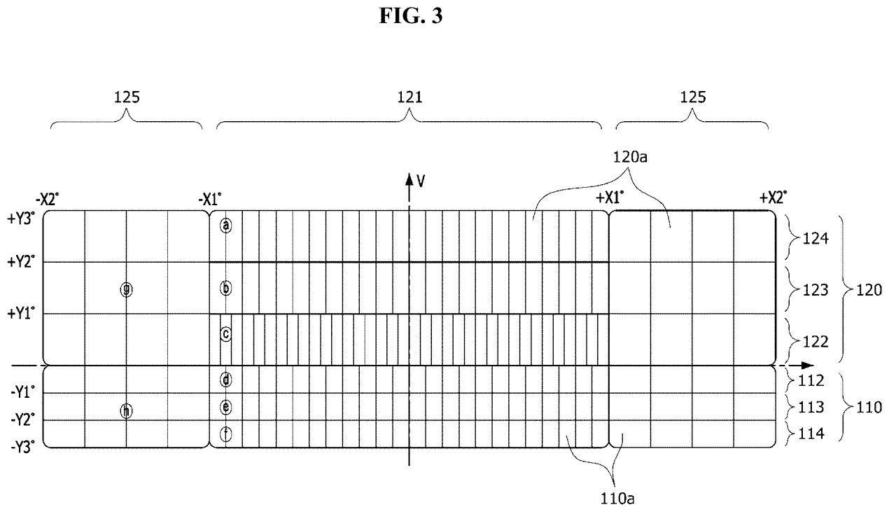

FIG. 2 is an exploded perspective view illustrating a headlamp for a vehicle in accordance with an embodiment of the present disclosure, and FIG. 3 is a diagram schematically illustrating a matrix beam pattern of a source module in the headlamp for a vehicle in accordance with the embodiment of the present disclosure.

Referring to FIG. 2, the headlamp 1 for a vehicle in accordance with the embodiment of the present disclosure includes a low beam source 110, a high beam source 120 and a control unit 10.

The headlamp 1 for a vehicle is implemented by sequentially assembling the control unit 10, a shade unit 20, a first bracket unit 30, a silicon lens unit 40, a second bracket unit 50 and an aspheric lens unit 60.

The control unit 10 includes a circuit board (not illustrated) on which a plurality of electronic elements (not illustrated) are mounted. A source module 100 is mounted on the circuit board (not illustrated), and includes the low beam source 110 and the high beam source 120.

The high beam source 120 is disposed at the top of the low beam source 110.

The low beam source 110 includes a plurality of low beam elements 110a arranged in a random matrix (for example, M rows*N columns), and the high beam source 120 includes a plurality of high beam elements 120a arranged in a random matrix (for example, M rows*N columns). However, the matrices (M rows*N columns) of the low beam source 110 and the high beam source 120 do not indicate the same matrix.

The silicon lens unit 40 includes a plurality of lenses (not illustrated) arranged in a matrix shape to correspond one-to-one to the plurality of low beam elements 110a and the plurality of high beam elements 120a. A low beam and a high beam, which are emitted from the low beam source 110 and the high beam source 120, are emitted through the silicon lens unit 40 and the aspheric lens unit 60.

The control unit 10 is electrically connected to a camera unit 70.

The camera unit 70 detects a target (or object) such as another vehicle (for example, oncoming vehicle or forward vehicle) (not illustrated) or a sign (not illustrated), which appears ahead of the vehicle.

The camera unit 70 transmits a captured signal to the control unit 10, and the control unit 10 reads the received signal and determines whether a target (or object) appears ahead of the vehicle.

The control unit 10 previously stores information on the low beam elements 110a and the high beam elements 120a, which correspond to locations ahead of the vehicle. Therefore, the control unit 10 may turn off some high beam elements 120a corresponding to the location of the target, and turn on the other high beam elements 120a which do not correspond to the location of the target. When the vehicle makes a turn, the control unit 10 may turn off or on some of the low beam element 110a or the high beam elements 120a.

The low beam source 110 includes the plurality of low beam elements 110a arranged in a matrix of M rows*N columns. For example, the low beam source 110 may include the plurality of low beam elements 110a arranged in a matrix of M rows*N columns in a lateral direction. The low beam source 110 may form a beam pattern corresponding to the matrix (M rows*N columns) in which the low beam elements 110a are arranged.

The high beam source 120 includes the plurality of high beam elements 120a arranged in a matrix of M rows*N columns. Therefore, the high beam source 120 may form a beam pattern corresponding to the matrix (M rows*N columns) in which the high beam elements 120a are arranged, and flicker only some high beam elements 120a. When a target such as another vehicle or a sign appears ahead of the vehicle, the high beam source 120 may form a darkness area corresponding to the target. On the other hand, when no target appears ahead of the vehicle, the high beam source 120 may form a light area. Therefore, the visibility of the driver in the nighttime may be improved.

Each of the high beam source 120 and the low beam source 110 includes a center source 121 and side sources 125 on both sides thereof. The center source 121 corresponds to a section of −X1° to +X1°, and the side sources 125 correspond to a section of −X1° to −X2° and a section of +X1° to +X2°, respectively. For example, −X1° may be set to −8.4°, −X2° may be set to −19.6°, +X1° may be set to 8.4°, and +X2° may be set to 19.6°.

The center source 121 of the high beam source 120 has the plurality of high beam elements 120a arranged in two or more lines, and the center source 121 of the low beam source 110 also has the plurality of low beam elements 110a arranged in two or more lines.

The side sources 125 are disposed on both sides of the center source 121, and the plurality of high beam elements 120a and the plurality of low beam elements 110a are arranged in an M*N matrix.

At this time, since the high and low beam elements of the center source 121 and the side sources 125 are arranged in two or more lines, the beam patterns of the center source 121 and the side sources 125 may be divided in the longitudinal direction. Furthermore, only some high beam elements 120a among the longitudinal high beam elements 120a of the center source 121 may be turned off, or only some low beam elements 110a among the longitudinal low beam elements 110a of the center source 121 may be turned off. Therefore, when a target appears ahead of the vehicle, a darkness area corresponding to the target may be formed. Furthermore, since the high beam elements 120a are arranged in an M*N matrix in the side source 125, a darkness area or light area can be formed in a desired area.

The center source 121 may have a greater luminous intensity than the side source 125.

At this time, all the high beam elements 120a of the center source 121 may have the same luminous intensity, and all of the high beam and low beam elements 120a and 110a of the side source 125 may also have the same luminous intensity.

The luminous intensities of the center source 121 and the side source 125 may be adjusted by controlling currents supplied to the high beam elements 120a and the low beam elements 110a.

At this time, the appearance frequency of a target is extremely high in a high beam area to which a beam is emitted from the center source 121, and low in a high beam area to which a beam is emitted from the side source 125. Therefore, a greater luminous intensity of beam may be emitted to the high beam area where the appearance frequency of the target is high, which makes it possible to improve the visibility of the driver in the nighttime. Furthermore, the power consumption of the side source 125 may be relatively reduced.

The luminous intensities of the high beam elements 120a may gradually decrease from the center of the center source 121 toward the outermost portion of the side source 125. At this time, the high beam elements 120a or the low beam elements 110a in the center of the center source 121 may have a greater luminous intensity than the high beam elements 120a or the low beam elements 110a on both sides of the center source 121.

The high beam elements 120a at the edge of the side source 125 may have a lower luminous intensity than the high beam elements 120a of the center source 121. Therefore, the center of a forward area of the vehicle is the brightest, and the brightness gradually decreases from the center to both sides of the forward area.

The control unit 10 may form a darkness area or light area by individually controlling the elements 110a and 120a of the low beam source 110 and the high beam source 120.

For example, the low beam source 110 may be controlled to turn on some low beam elements 110a disposed in a turning direction of the vehicle, and turn off some low beam elements 110a disposed in the opposite side of the turning direction of the vehicle, thereby performing an EDBL (Electric Dynamic Bending Light) function of preventing a low beam of the low beam source 110 from being emitted to an opponent vehicle.

Furthermore, as some low beam elements 110a disposed on the opposite side of the turning direction of the vehicle are turned off, the EDBL function may be electrically implemented without rotating the source module 100 in the turning direction of the vehicle, and variable resolution may be applied. Thus, a separate actuator for rotating the source module 100 may not be installed.

Hereafter, for convenience of description, in the center source 121, a first row 122 of the high beam source 120, for example, a section of 0 to +Y1°, may be represented by an area \textcircled{c}, a second row 123 of the high beam source 120, for example, a section of +Y1° to +Y2° may be represented by an area \textcircled{b}, and a third row 124 of the high beam source 120, for example, a section of +Y2° to +Y3° may be represented by an area \textcircled{a}. Furthermore, in the center source 121, a first row 112 of the low beam source 110, for example, a section of 0 to −Y1° may be represented by an area \textcircled{d}, a second row 113 of the low beam source 110, for example, a section of −Y1° to −Y2° may be represented by an area \textcircled{e}, and a third row 114 of the low beam source 110, for example, a section of −Y2° to −Y3° may be represented by an area \textcircled{f}. For example, +Y1° may be set to 2.1°, +Y2° may be set to 4.2°, +Y3° may be set to 6.3°, −Y1° may be set to −0.7°, +Y2° may be set to −1.4°, and −Y3° may be set to −2.1°.

As illustrated in FIG. 3, the beam pattern in accordance with the present embodiment includes a forward vehicle following area, an oncoming vehicle following area, a glare prevention area and an openness securing area in the case of the high beam source 120. The forward vehicle following area, i.e. the area \textcircled{c}, is constituted by rectangular beam patterns each having a dimension of about 2° in the top-to-bottom direction and about 0.5° in the side-to-side direction, and serves an area for an ADB (Adaptive Driving Beam) function. The oncoming vehicle following area, i.e. the area \textcircled{g}, is constituted by rectangular beam patterns each having a dimension of about 2° in the top-to-bottom direction and about 2 to 3° in the side-to-side direction. The glare prevention area, i.e. the area \textcircled{b}, is constituted by rectangular beam patterns each having a dimension of about 2° in the top-to-bottom direction and about 0.7° in the side-to-side direction, and serves as an area for preventing glare of a driver by sign reflection. The openness securing area, i.e. the area \textcircled{a}, is constituted by rectangular beam patterns each having a dimension of about 2° in the top-to-bottom direction and about 0.7° in the side-to-side direction, and serves as an area for making the driver feel openness when there is no forward vehicle or oncoming vehicle.

As illustrated in FIG. 3, the beam pattern in accordance with the present embodiment includes a low beam cut-off area, a spot light area and an oncoming vehicle following area in the case of the low beam source 110. The low beam cut-off area, i.e. the area \textcircled{d}, is constituted by square beam patterns each having a dimension of about 0.7°, and serves as an area for implementing cut-off and DBL (Dynamic Bending Light). The spot light area, i.e. the areas \textcircled{e} and \textcircled{f}, is constituted by square beam patterns each having a dimension of about 0.7°, and serves as an area for making the driver recognize the presence of a pedestrian or hazard ahead of the vehicle through a direct or indirect method. The oncoming vehicle following area, i.e. the area \textcircled{h}, is constituted by rectangular beam patterns each having a dimension of about 0.7° in the top-to-bottom direction and about 2 to 3° in the side-to-side direction.

As described above, the matrix beam pattern in accordance with the present embodiment may include the plurality of functional areas \textcircled{a} to \textcircled{h} with a resolution of about 0.5° to 2° to implement a beam pattern, and thus increase the visibility in the nighttime. Therefore, the stability and convenience may be improved. For example, the center source 121 is an area or section having higher resolution than the side source 125, and the side source 125 is an area or section having lower resolution than the center source 121.

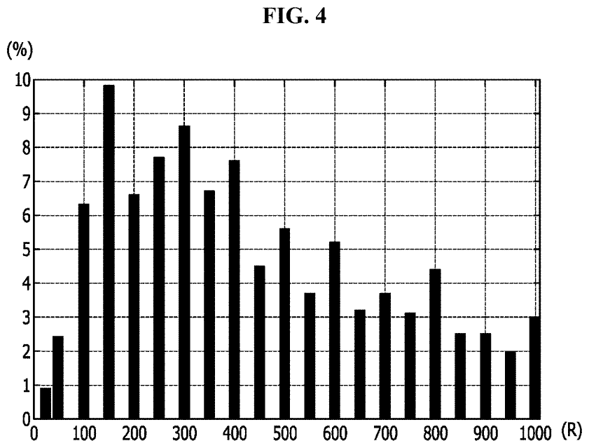

FIG. 4 is a graph illustrating the road curvature distribution of a specific country in relation to the embodiment of the present disclosure. As illustrated in FIG. 4, a result obtained by analyzing road curvatures of the specific country (for example, German) shows that roads with a curvature equal to or less than 1000 R are 98%.

When roads with a curvature equal to or less than 150 R are excluded because an ADB service condition (for example, a traveling speed of 40 KPH or more) is not satisfied so that it is difficult for vehicles to travel on the roads, a curvature region of interest, to which the present disclosure can be applied, may be set in the range of 150 R to 1000 R. In this case, the present disclosure may be applied to 90% or more of roads.

As an FOV (Field of View) of ±20° or more is required, a camera whose FOV is about ±25° may be applied.

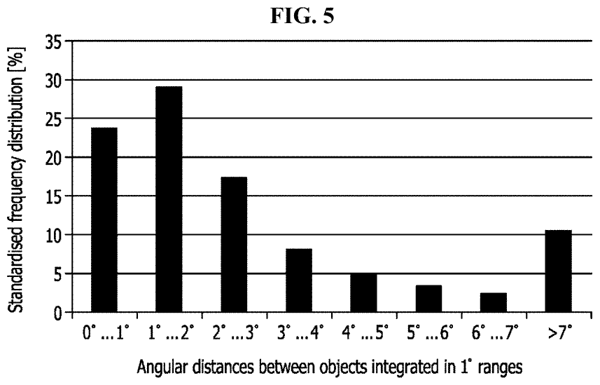

FIG. 5 is a graph illustrating the standardized frequency distribution of vehicles for each camera angle in relation to the embodiment of the present disclosure. As illustrated in FIG. 5, a result obtained by analyzing the standardized frequency distribution of vehicles for each camera angle through an actual test shows that 80% or more of vehicles are distributed in a section of ±7°.

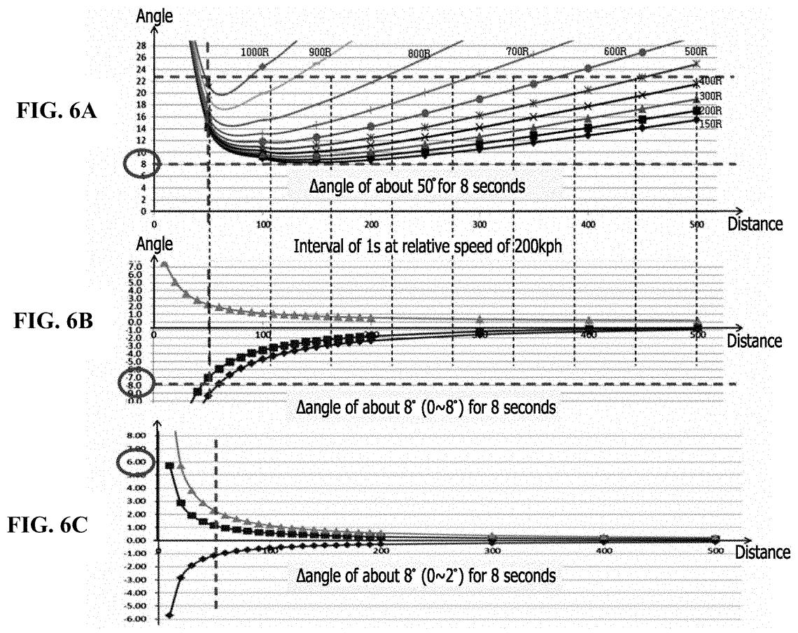

FIGS. 6A to 6C are graphs showing results obtained by analyzing camera detection distribution probabilities for a forward vehicle and an oncoming vehicle in relation to the embodiment of the present disclosure. FIG. 6A is a graph showing a change in angle of an oncoming vehicle depending on a distance when a vehicle travels on a curved road, FIG. 6B is a graph showing a change in angle of an oncoming vehicle depending on a distance when a vehicle travels on a straight road, and FIG. 6C is a graph showing a change in angle of an oncoming vehicle depending on a distance when a vehicle travels on a straight road.

Referring to FIGS. 6A to 6C, a result obtained by performing a traveling environment simulation within a curvature of interest shows that a forward vehicle and an oncoming vehicle can be distinguished from each other at an angle of 8°. Based on the simulation result, the center of the beam pattern (i.e. center source) for a forward vehicle and an oncoming vehicle may be controlled in a straight road section, and the edge of the beam pattern (i.e. side source) for a forward vehicle and an oncoming vehicle may be controlled in a curved road section.

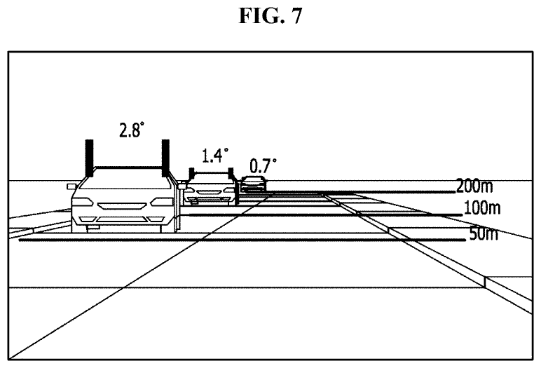

FIG. 7 is a diagram comparatively illustrating a vehicle size depending on distance in order to decide beam pattern resolution for controlling the headlamp in accordance with the embodiment of the present disclosure. As illustrated in FIG. 7, the vehicle size corresponds to 0.7° when a maximum distance designated for a forward vehicle according to the rules is 200 m. Therefore, a driving margin rate may be reflected to set the beam pattern resolution to about 0.5° (see the area \textcircled{c} of FIG. 3).

In the case of an oncoming vehicle, a maximum displacement of 15° (based on 500 R) may occur in a section of six seconds. When the distance is 50 m (see FIG. 6A), the vehicle size corresponds to about 2.8°. Therefore, the driving margin rate may be reflected to set the beam pattern resolution to about 3° (see the area \textcircled{g} of FIG. 3).

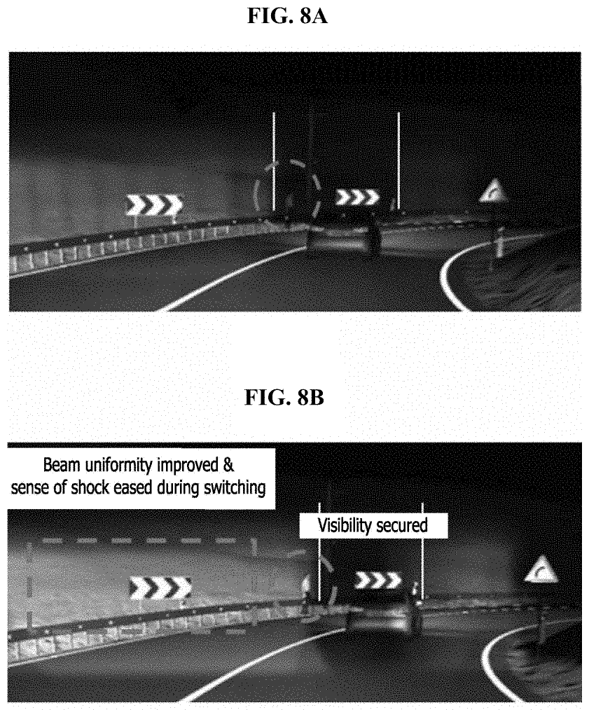

FIGS. 8A and 8B are photographs comparatively showing simulation results on a curved road in order to decide beam pattern resolution for controlling the headlamp in accordance with the embodiment of the present disclosure. In the ADB service area (see the area \textcircled{c} of FIG. 3), FIG. 8A shows a result obtained by performing a simulation at a resolution of 1.5°, and FIG. 8B shows a result obtained by performing a simulation at a resolution of 0.5°.

As shown in FIG. 8B which shows a result obtained by controlling the headlamp at a resolution of 0.5° in comparison to a resolution of 1.5°, beam uniformity can be improved, a sense of shock can be eased when the beam pattern is switched in a rotation direction in response to a curved road, and the visibility for a forward target (for example, pedestrian or sign) can be improved.

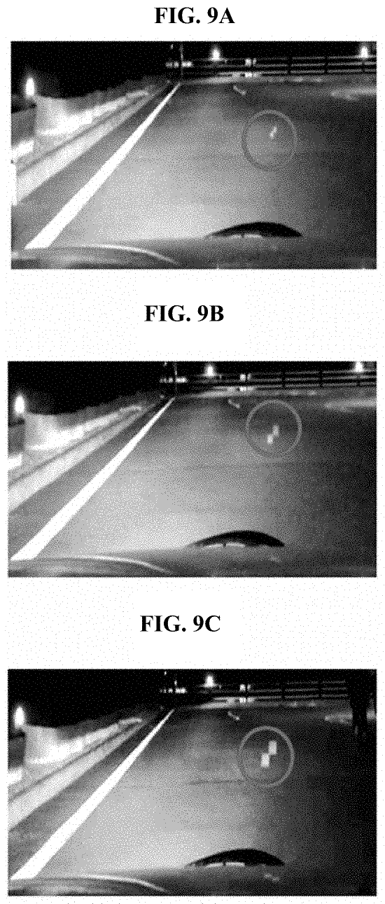

FIGS. 9A to 9C are photographs comparatively showing simulation results to decide the resolution of a spot light beam pattern for controlling the headlamp in accordance with the embodiment of the present disclosure. FIG. 9A is a photograph showing a result obtained by performing a simulation at a resolution of 0.3° (for example, imaging test result) in the spot light area (see the areas \textcircled{e} and \textcircled{f} of FIG. 3), FIG. 9B is a photograph showing a result obtained by performing a simulation at a resolution of 0.5° in the spot light area, and FIG. 9C is a photograph showing a result obtained by performing a simulation at a resolution of 0.7° in the spot light area.

As shown in FIG. 9C which shows a result obtained by controlling the headlamp at a resolution of 0.7° in comparison to a resolution of 0.3° or 0.5°, the visibility for a forward target (for example, hazard) on the road can be improved, and the visibility for a neighboring target (for example, pedestrian) can also be improved.

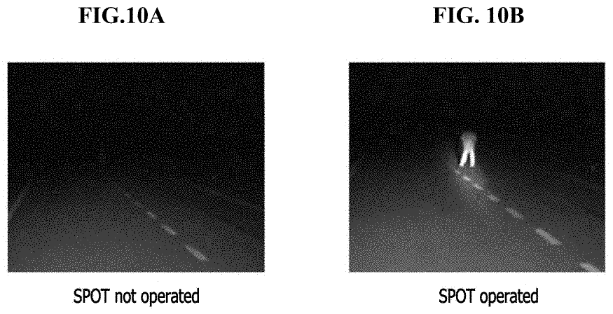

FIGS. 10A and 10B are photographs comparatively showing simulation results for checking visibility when a spot light function is operated and when the spot light function is not operated in FIG. 9. When the spot light function is operated (see FIG. 10B) in comparison to when the spot light function is not operated (see FIG. 10A), the visibility for a target (for example, pedestrian) can be improved.

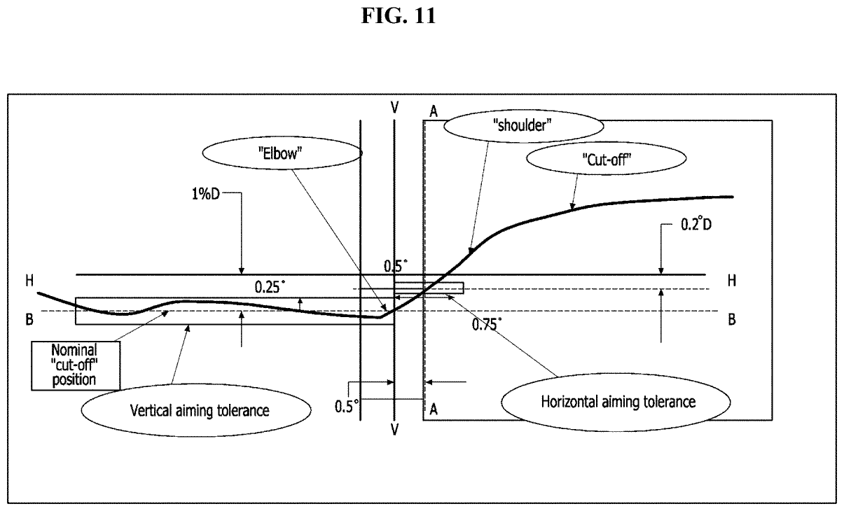

FIG. 11 is a diagram illustrating a cut-off line rule for deciding the beam pattern resolution of a low beam cut-off area for controlling the headlamp in accordance with the embodiment of the present disclosure, and the low beam cut-off area (see the area \textcircled{d} of FIG. 3) in accordance with the present embodiment is configured as square beam patterns of about 0.7°, in order to satisfy the rule.

For example, according to the cut-off line rule, “Shoulder” above 0.2° line (i.e. 0.2° D) from a cut-off line must not go to the left side of a line A (or must not cross the line A). That is, the 0.2° line or a pixel under the 0.2° line (i.e. beam pattern) is controlled to coincide with the line A, and “Elbow” on the cut-off line needs to fall within ±0.5° based on a line V. Thus, the cut-off is implemented at −0.57° on the left side of “Shoulder”. Therefore, the low beam cut-off area (see the area \textcircled{d} of FIG. 3) in accordance with the present embodiment is configured as square beam patterns of about 0.7° in order to satisfy the cut-off line rule.

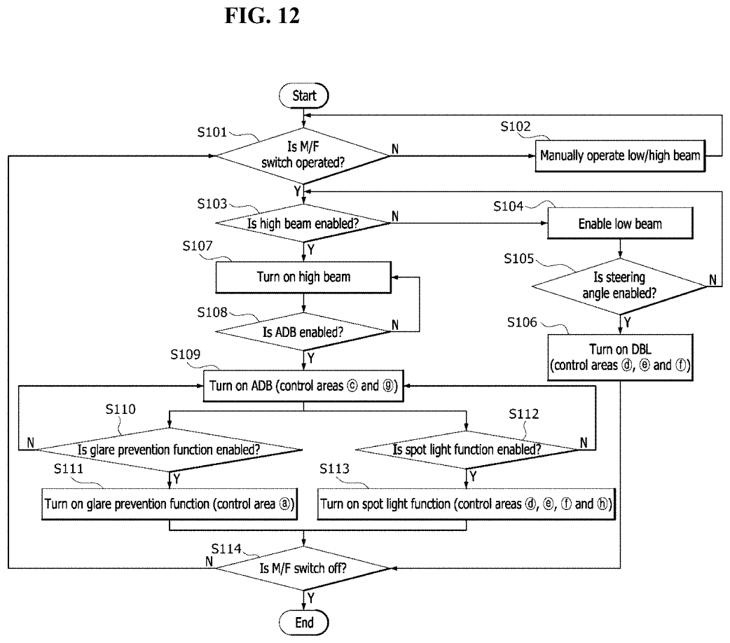

Hereafter, a method for controlling a headlamp for a vehicle, which implements a matrix beam pattern including the plurality of functional areas \textcircled{a} to \textcircled{h} at a resolution of about 0.5° to 2° as illustrated in FIG. 3, will be described with reference to FIG. 12.

FIG. 12 is a flowchart for describing a method for controlling a headlamp for a vehicle in accordance with an embodiment of the present disclosure.

Referring to FIG. 12, when an M/F (Multi-Function) switch is set to auto (Yes in step S101), the control unit 10 turns on the high beam in step S107 in case of a high beam enable condition (Yes in step S103) in which the M/F switch is set to auto, the vehicle speed is equal to or more than 40 KPH, camera information indicates that there is no vehicle (for example, no oncoming vehicle or forward vehicle) ahead of the vehicle, and the traveling area is not a downtown area.

When the M/F switch is not set to auto (No in step S101), the low beam or the high beam is manually operated in step S102. When the high beam enable condition is not satisfied (No in step S103), the control unit 10 enables the low beam in step S104. At this time, depending on a steering angle (Yes in step S105), a low beam element for DBL (for example, LED) is turned on/off according to the beam pattern in step S106.

When information on a forward vehicle detected through the camera unit 70 is inputted in the case that the ADB function is enabled (Yes in step S108) while the high beam is turned on in step S107, the control unit 10 generates a darkness area by controlling a beam pattern area corresponding to the forward area in a designated area (for example, the areas \textcircled{c} and \textcircled{g} in FIG. 3).

At this time, the level of the darkness area may be adjusted.

When a glare prevention function is enabled (Yes in step S110) in the case that a forward sign is detected through the camera unit 70 while the ADB function is enabled (Yes in step S108), the control unit 10 generates a darkness area by controlling a beam pattern area corresponding to the sign in a designated area (for example, the area \textcircled{a} of FIG. 3) in step S111.

At this time, the level of the darkness area may be adjusted.

When the spot light function is enabled (Yes in step S112) in the case that a forward target (for example, pedestrian or hazard) is detected through the camera unit 70 while the ADB function is enabled (Yes in step S108), the control unit 10 generates a light area (or flickering at 4 Hz) by controlling a beam pattern area corresponding to the target in a designated area (the areas \textcircled{d}, \textcircled{e}, \textcircled{f} and \textcircled{h} of FIG. 3), thereby making the driver recognize the location and direction of the target in step S113.

The above-described process S101 to S113 is repeatedly performed until the M/F switch is released from auto (No in step S114). When the M/F switch is released from auto (Yes in step S114), the mode is switched to the manual mode.

As described above, the headlamp for a vehicle and the control method thereof in accordance with the embodiment of the present disclosure can improve the visibility of a driver while preventing glare of the driver, caused by a sign, form a small darkness area in the lateral and longitudinal directions, increase the driving stability by previously identifying the location of a pedestrian or hazard and making the driver recognize the location of the pedestrian or hazard, and adjust a light-on area in units of small areas in response to the turning direction of the vehicle, thereby improving the visibility of the driver in the nighttime.

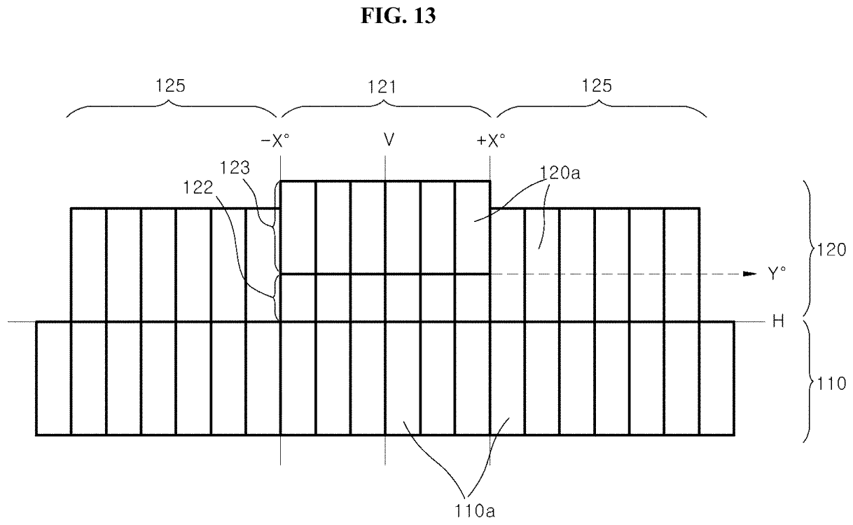

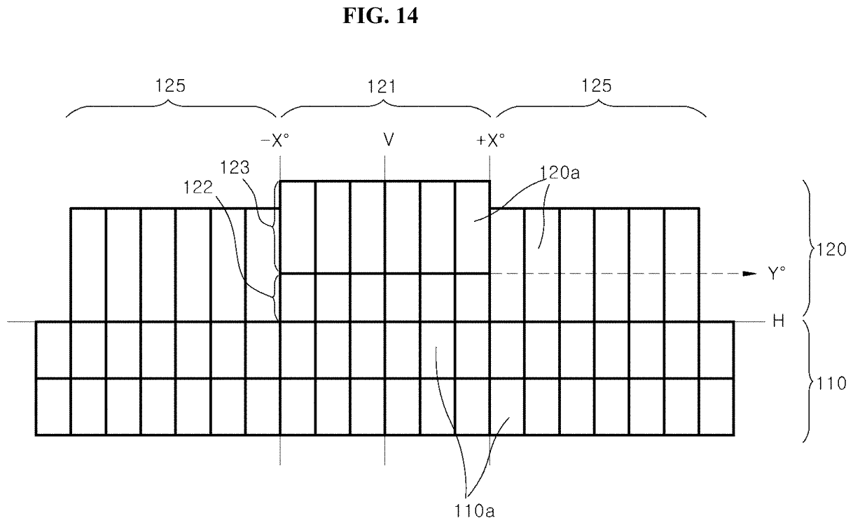

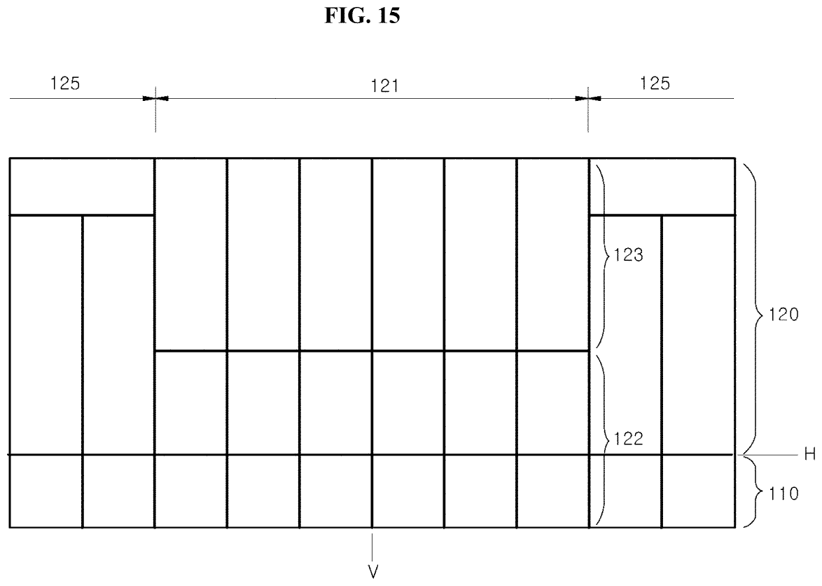

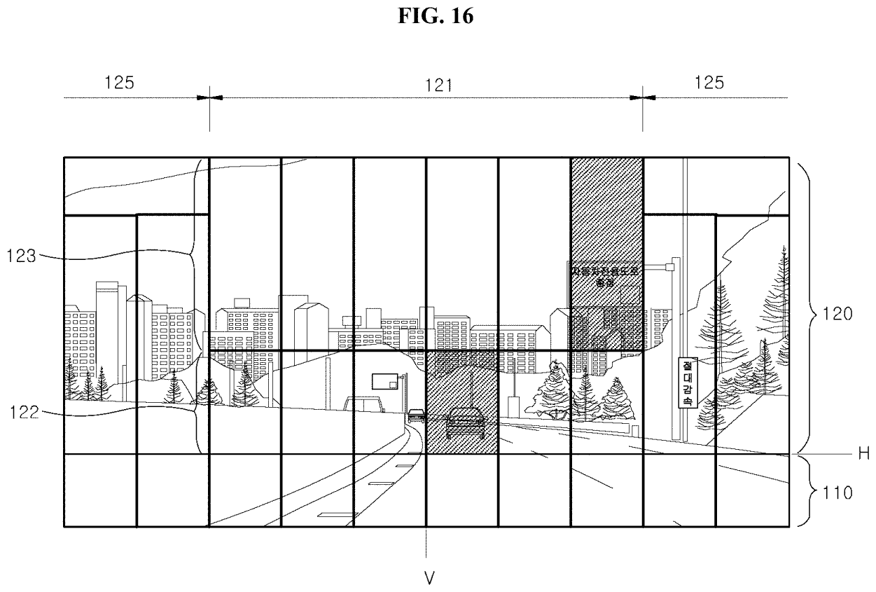

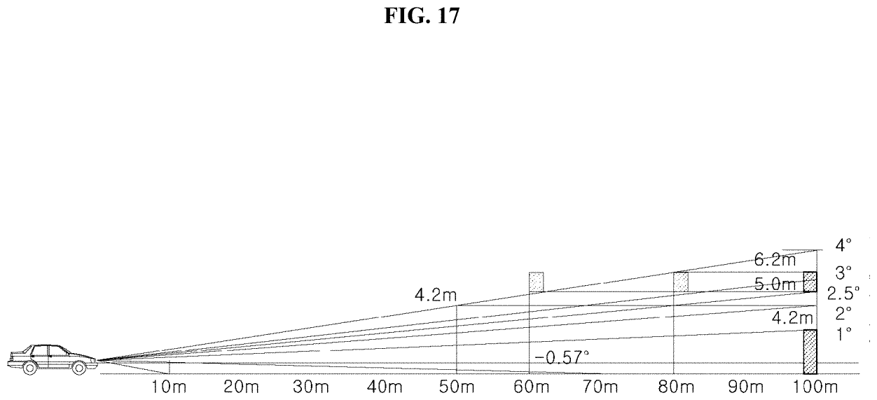

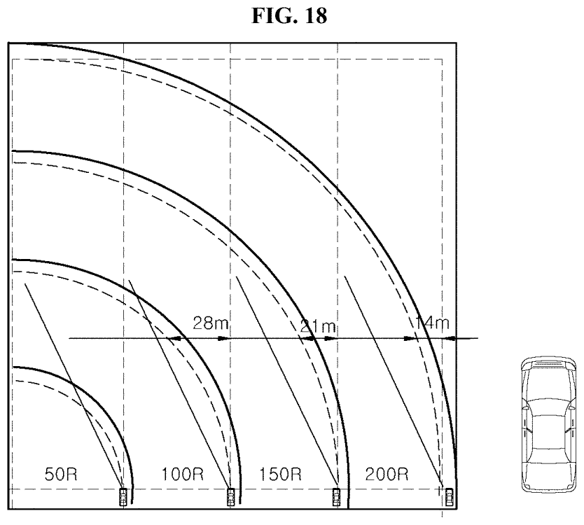

FIG. 13 is a diagram schematically illustrating a low beam source and a high beam source of a source module in a headlamp for a vehicle in accordance with another embodiment of the present disclosure, FIG. 14 is a diagram schematically illustrating that low beam elements of the low beam source are arranged in two lines in the source module of the headlamp for a vehicle in accordance with the embodiment of the present disclosure, FIG. 15 is a diagram schematically illustrating the high beam source of the source module in the headlamp for a vehicle in accordance with the embodiment of the present disclosure, FIG. 16 is a diagram schematically illustrating that darkness areas are formed in high beam elements corresponding to targets in the headlamp for a vehicle in accordance with the embodiment of the present disclosure, FIG. 17 is a diagram schematically illustrating longitudinal inclination angles of low and high beams in the headlamp for a vehicle in accordance with the embodiment of the present disclosure, and FIG. 18 is a diagram schematically illustrating the width of a viewing angle of a driver depending on the curvature of a curved road in the headlamp for a vehicle in accordance with the embodiment of the present disclosure.

In the following descriptions, the same components as those of the headlamp for a vehicle in accordance with the embodiment of the present disclosure will be represented by like reference numerals, and the detailed descriptions thereof will be omitted herein.

A low beam source 110 includes a plurality of low beam elements 110a. For example, the low beam source 110 includes the plurality of low beam elements 110a arranged in a line in a lateral direction (see FIG. 13). Alternatively, the low beam source 110 may includes low beam elements 110a arranged in two or more lines in the lateral direction (see FIG. 14). When the low beam elements 110a are arranged in a line, it is possible to form a beam pattern having a larger size in the lateral direction and the longitudinal direction than when the low beam elements 110a are arranged in two or more lines.

A high beam source 120 includes a plurality of high beam elements 120a arranged in two or more lines. Therefore, since the beam pattern is divided in the longitudinal direction by the plural lines of high beam elements 120a, only some high beam elements 120a among the longitudinal high beam elements 120a may be flickered. Furthermore, when a target such as another vehicle or sign appears ahead of the vehicle, the high beam source 120 may form a small darkness area. Furthermore, when no target appears ahead of the vehicle, the high beam source 120 may form a light area. Therefore, the visibility of the driver may be improved.

A center source 121 includes the plurality of high beam elements 120a arranged in two or more lines. A side source 125 is disposed on either side of the center source 121, and has the plurality of high beam elements 120a arranged in a line.

Since the high beam elements of the center source 121 are arranged in two or more lines, the beam pattern of the high beam of the center source 121 may be divided in the longitudinal direction, and only some high beam elements 120a among the longitudinal high beam elements 120a of the center source 121 may be turned off. Therefore, when a target appears ahead of the vehicle, a small darkness area may be formed in the longitudinal direction. Furthermore, since the side source 125 includes the high beam elements 120a arranged in a line, the number of high beam elements 120a installed in the side source 125 can be reduced, and the fabrication cost of the headlamp 1 for a vehicle can be reduced.

The center source 121 may have a greater luminous intensity than the side source 125. At this time, all of the high beam elements 120a of the center source 121 may have the same luminous intensity, and all of the high beam elements 120a of the side source 125 may also have the same luminous intensity. Furthermore, the luminous intensities of the center source 121 and the side source 125 may be adjusted by controlling a current supplied to the high beam elements 120a.

At this time, the appearance frequency of a target is extremely high in a high beam area to which a beam is emitted from the center source 121, and low in a high beam area to which a beam is emitted from the side source 125. Therefore, a greater luminous intensity of beam may be emitted to the high beam area where the appearance frequency of the target is high, which makes it possible to further improve the visibility of the driver. Furthermore, the power consumption of the side source 125 can be relatively reduced.

The luminous intensities of the high beam elements 120a may gradually decrease from the center of the center source 121 toward the outermost portion of the side source 125. At this time, the high beam elements 120a in the center of the center source 121 have a greater luminous intensity than the high beam elements 120a on both sides of the center source 121. Furthermore, the high beam elements 120a at the edge of the side source 125 have a lower luminous intensity than the high beam elements 120a of the center source 121. Therefore, the center of the forward area of the vehicle is the brightest, and the brightness gradually decreases from the center toward both sides of the forward area.

The center source 121 includes a first center high beam unit 122 and a second center high beam unit 123. The first center high beam unit 122 is laterally disposed in the center source 121 at the low beam source 110. The second center high beam unit 123 is laterally disposed at the top of the first center high beam unit 122. The first center high beam unit 122 and the second center high beam unit 123 are disposed in parallel to each other in the lateral direction.

The first center high beam unit 122 emits a high beam at an inclination angle of 1.5 to 4° in the longitudinal direction. For example, when the first center high beam unit 122 is turned on and the second center high beam unit 123 is turned off, the first center high beam unit 122 emits a high beam at an inclination angle of 1.5 to 4° in the longitudinal direction. Therefore, since a forward vehicle is already located in a low beam area within a distance of 70 m ahead of the vehicle, the visibility can be secured even though the second center high beam unit 123 is turned off.

The second center high beam unit 123 emits a high beam at an inclination angle of 0.7 to 4° in the longitudinal direction. For example, when the second center high beam unit 123 is turned on and the first center high beam unit 122 is turned off, the second center high beam unit 123 emits a high beam at an inclination angle of 0.7 to 4° in the longitudinal direction. Since the sign recognition distance of the driver ranges from 50 m to 100 m, the inclination angle of the second center high beam unit 123 at the corresponding location ranges from 2° to 4°. At this time, when the inclination angle of the high beam of the first center high beam unit 122 is equal to or less than the inclination angle of the high beam of the second center high beam unit 123, the first center high beam unit 122 may be lit up at all times. However, since the visibility is improved as the inclination angle of the high beam of the second center high beam unit 123 is increased, the inclination angle of the high beam of the second center high beam unit 123 may be set to an inclination angle of 2.5° to 4°. Furthermore, when the inclination angle of the high beam of the second center high beam unit 123 is equal to or more than 2°, a driver in the forward vehicle hardly feels glare till a distance of 60 m from the forward vehicle.

The low beam source 110 is controlled to turn on some low beam elements 110a arranged in the turning direction of the vehicle, and turn off some low beam elements 110a arranged on the opposite side of the turning direction of the vehicle. Therefore, an EDBL function may be performed to prevent a low beam of the low beam source 110 from being emitted to the opponent vehicle. This function will be described in detail.

The inclination angle of the low beam emitted from the low beam source 110 is increased by about 0.57° from a driver seat toward a passenger seat. When a curved road is formed at a curvature of 50 R corresponding to a radius of 50 m, the low beam emitted from the low beam source 110 has almost no influence on glare of the driver in the opponent vehicle. Thus, the EDBL function is not required. The EDBL function indicates that the source module 100 is rotated in the turning direction of the vehicle to prevent glare of the driver in the opponent vehicle.

When the curved road is formed at a curvature of 100 R corresponding to a radius of 100 m, the width of the viewing angle of the driver becomes 28 m at a distance of 70 from the vehicle.

When the curved road is formed at a curvature of 150 R corresponding to a radius of 150 m, the width of the visibility angle of the driver becomes 21 m at a distance of 70 from the vehicle.

When the curved road is formed at a curvature of 200 R corresponding to a radius of 200 m, the width of the visibility angle of the driver becomes 14 m at a distance of 70 from the vehicle.

Therefore, in the case of a curved road formed at a curvature of 200 R corresponding to a radius of 200 m or more, some low beam elements 110a disposed on the opposite side of the turning direction of the vehicle may be individually turned off to prevent glare of the driver in the opponent vehicle on the curved road. Furthermore, as some low beam elements 110a disposed on the opposite side of the turning direction of the vehicle are turned off, the EDBL function can be electrically implemented without rotating the source module 100 in the turning direction of the vehicle, and variable resolution can be applied. Furthermore, a separate actuator for rotating the source module 100 may not be installed.

Hereafter, a method for controlling the headlamp for a vehicle in accordance with another embodiment of the present disclosure, which is configured as described above, will be described.

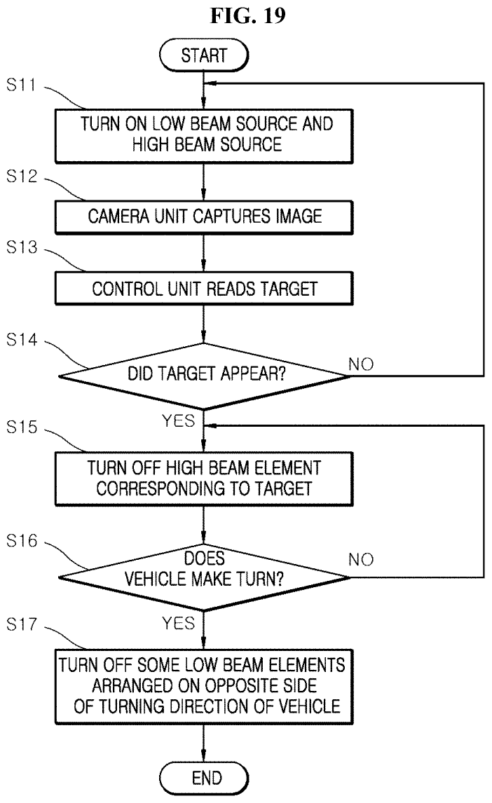

Referring to FIG. 19, the low beam source 110 and the high beam source 120 are turned on in step S11, when the vehicle travels. At this time, the low beam source 110 emits a low beam below a horizontal plane, and the high beam source 120 emits a high beam in a range of about 4° from the horizontal plane.

The camera unit 70 films a forward area of the vehicle in step S12. An image data signal captured by the camera unit 70 is transmitted to the control unit 10.

The control unit 10 reads a target by computing the received image data signal in step S13. The control unit 10 previously stores information on the low beam elements 110a and s the high beam elements 120a, which correspond to locations ahead of the vehicle.

The control unit 10 reads the received signal, and determines whether a target appears ahead of the vehicle, in step S14. When the control unit 10 determines that no target appeared, the low beam source 110 and the high beam source 120 are continuously lit up. Furthermore, the camera unit 70 continuously films the forward area of the vehicle.

At this time, a greater luminous intensity of beam may be emitted to a high beam area where the appearance frequency of the target is high, which makes it possible to improve the visibility of the driver. Furthermore, the power consumption of the side source 125 may be relatively reduced.

The luminous intensities of the high beam elements 120a may gradually decrease from the center of the center source 121 toward the outermost part of the side source 125. Therefore, the center of the forward area of the vehicle is the brightest, and the brightness gradually decreases from the center toward both sides of the forward area.

The first center high beam unit 122 emits a high beam at an inclination angle of 1.5 to 4° in the longitudinal direction. Therefore, since a forward vehicle is already located in the low beam area within a distance of 70 m ahead of the vehicle, the visibility can be secured even though the second center high beam unit 123 is turned off.

The second center high beam unit 123 emits a high beam at an inclination angle of 0.7 to 4° in the longitudinal direction.

When determining that a target appeared, the control unit 10 turns off the high beam element 120a corresponding to the target. At this time, when the target is an oncoming vehicle, the high beam area corresponding to the oncoming vehicle is turned off. Furthermore, when the target is a sign, a high beam area corresponding to the sign is turned off. Although the location of the target is changed as the vehicle travels, another high beam element 120a corresponding to the changed location is turned off.

Therefore, since a darkness area is formed in the high beam area corresponding to the target, the driver can recognize the target more clearly. Furthermore, since the darkness area formed in the longitudinal direction of the high beam element 120a may have a relatively small size, the visibility of the driver can be secured.

The control unit 10 determines whether the vehicle makes a turn, in step S16. When determining that the vehicle does not make a turn, the control unit 10 maintains the state in which all the low beam elements 110a are turned on.

When determining that the vehicle makes a turn, the control unit 10 turns off some low beam elements 110a disposed on the opposite side of the turning direction of the vehicle, in step S17. Therefore, the EDBL function may be performed to prevent a low beam of the low beam source 110 from being emitted to the opponent vehicle.

Although the present disclosure has been disclosed with reference to the embodiments illustrated in the drawings, the embodiments are only for illustrative purposes, and those skilled in the art will appreciate that various modifications and other equivalent embodiments are possible. Thus, the technical protection scope of the present disclosure should be defined by the following claims. Furthermore, the embodiments described in this specification may be implemented with a method or process, a device, a software program or a signal, for example. Although the embodiments have been discussed in a single implementation (for example, only in a method), the discussed features can be implemented in other forms (for example, device or program). The device can be implemented in proper hardware, software, firmware and the like. The method can be implemented in a device such as a processor which generally refers to a processing device including a computer, a microprocessor, an integrated circuit or a programmable logic device.

What is claimed is:

1. A headlamp for a vehicle, comprising:
a low beam source including a plurality of low beam elements arranged in a designated matrix;
a high beam source including a plurality of high beam elements arranged in a designated matrix; and
a control unit configured to generate a darkness area or light area by selectively turning on/off the high beam elements and the low beam element based on a designated matrix beam pattern, according to whether a target is detected.

2. The headlamp of claim 1, wherein each of the low beam source and the high beam source comprises a center source and side sources disposed on both sides of the center source, and the center source has higher beam pattern resolution than the side source.

3. The headlamp of claim 2, wherein the center source has a greater luminous intensity than the side source.

4. The headlamp of claim 2, wherein:
the center source is set to a section of −X1° to +X1°; and
the side sources are set to a section of −X1° to −X2° and a section of +X1° to +X2°, respectively, wherein −X1° is −8.4°, −X2° is −19.6°, +X1° is 8.4°, and +X2° is 19.6°.

5. The headlamp of claim 2, wherein:
the high beam source has a plurality of high beam elements arranged in three or more rows, and comprises a first row set to a section of 0 to +Y1°, a second row set to a section of +Y1° to +Y2°, and a third row set to a section of +Y2° to +Y3°; and
+Y1° is 2.1°, +Y2° is 4.2°, and +Y3° is 6.3°.

6. The headlamp of claim 2, wherein:
the low beam source has a plurality of low beam elements arranged in three or more rows, and comprises a first row set to a section of 0 to −Y1°, a second row set to a section of −Y1° to −Y2°, and a third row set to a section of −Y2° to −Y3°; and
−Y1° is 0.7°, +Y2° is −1.4°, and −Y3° is −2.1°.

7. The headlamp of claim 2, wherein the beam pattern comprises, in the center source section of the high beam source:
a forward vehicle following area constituted by rectangular beam patterns, each having a dimension of 2° in the top-to-bottom direction and 0.5° in the side-to-side direction, and serving as an area for an ADB (Adaptive Driving Beam) function;
a glare prevention area constituted by rectangular beam patterns, each having a dimension of 2° in the top-to-bottom direction and 0.7° in the side-to-side direction, and serving as an area for preventing glare of a driver, caused by sign reflection; and
an openness securing area constituted by rectangular beam patterns, each having a dimension of 2° in the top-to-bottom direction and 0.7° in the side-to-side direction, and serving as an area for making a driver feel openness, when there is no forward vehicle or oncoming vehicle.

8. The headlamp of claim 2, wherein the beam pattern comprises, in the center source section of the low beam source:
a low beam cut-off area constituted by square beam patterns, each having a dimension of 0.7°, and serving as an area for implementing cut-off and DBL (Dynamic Bending Light); and
a spot light area constituted by square beam patterns, each having a dimension of 0.7°, and serving as an area for making a driver recognize the presence of a pedestrian or hazard ahead of the vehicle through a direct or indirect method.

9. The headlamp of claim 2, wherein the beam pattern comprises, in the side source section of the high beam source, an oncoming vehicle following area constituted by rectangular beam patterns each having a dimension of 2° in the top-to-bottom direction and 2° to 3° in the side-to-side direction.

10. The headlamp of claim 2, wherein the beam pattern comprises, in the side source section of the low beam source, an oncoming vehicle following area constituted by rectangular beam patterns each having a dimension of 0.7° in the top-to-bottom direction and 2° to 3° in the side-to-side direction.

11. A method for controlling a headlamp for a vehicle, comprising, when an Adaptive Driving Beam (ADB) function is enabled while a high beam of the headlamp for a vehicle is turned on:
receiving, by a control unit, information on a forward vehicle detected through a camera unit; and
generating, by the control unit, a darkness area by controlling a beam pattern area corresponding to the forward vehicle in a designated forward vehicle following area among beam pattern areas of the headlamp for a vehicle.

12. The method of claim 11, further comprising:
receiving, by the control unit, information on a forward sign detected through the camera unit, when the ADB function is enabled while the high beam of the headlamp for a vehicle is turned on; and
generating, by the control unit, a darkness area by controlling a beam pattern area corresponding to the forward sign in a designated glare prevention area among the beam pattern areas of the headlamp for a vehicle, when a glare prevention function is enabled.

13. The method of claim 11, further comprising:
receiving, by the control unit, information on a forward target detected through the camera unit, when the ADB function is enabled while the high beam of the headlamp for a vehicle is turned on; and
generating, by the control unit, a light area or generating flickering at a designated frequency, by controlling a beam pattern area corresponding to the forward target in a designated spot light area among the beam pattern areas of the headlamp for a vehicle, when a spot light function is enabled.

14. The method of claim 11, wherein, when the high beam of the headlamp for a vehicle is turned on, a M/F (Multi-Function) switch is set to auto; and
when a high beam enable condition is satisfied, the control unit turns on the high beam, and
wherein the high beam enable condition indicates that vehicle speed is equal to or greater than a designated speed, and there is no vehicle in a forward area and the traveling area is not a downtown area according to information detected through a camera unit, while the M/F switch is set to auto.

15. The method of claim 14, wherein, when the high beam enable condition is not satisfied, the control unit enables a low beam, and turns on/off low beam elements for DBL according to a designated beam pattern depending on a steering angle.

16. A headlamp for a vehicle, comprising:
a low beam source including a plurality of low beam elements;
a high beam source including a plurality of high beam elements arranged in two or more lines; and
a control unit configured to turn off the high beam element corresponding to a target when the target is detected, and turn on the high beam element when no target is detected.

17. The headlamp of claim 16, wherein the high beam source comprises:
a center source having a plurality of high beam elements arranged in two or more lines; and
a side source disposed on either side of the center source, and having the plurality of high beam elements arranged in a line.

18. The headlamp of claim 17, wherein:
the center source comprises:
a first center high beam unit disposed in a lateral direction at the low beam source; and
a second center high beam unit disposed in a lateral direction at the top of the first center high beam unit; and
the first center high beam unit is configured to emit a high beam at an inclination angle of 1.5 to 4° in a longitudinal direction.

19. The headlamp of claim 18, wherein the second center high beam unit is configured to emit a high beam at an inclination angle of 0.7° to 4° in the longitudinal direction.

20. The headlamp of claim 16, wherein the low beam source is controlled to turn on some low beam elements disposed in a turning direction of the vehicle, and turn off some low beam elements disposed on the opposite side of the turning direction of the vehicle.
